(19) United States
(12) Patent Application Publication
(10) Pub. No.: US 2024/0204619 A1
(43) Pub. Date: Jun. 20, 2024

(54) ELECTRIC GENERATOR FOR A WIND TURBINE AND WIND TURBINE

(71) Applicant: Siemens Gamesa Renewable Energy A/S, Brande (DK)

(72) Inventors: Ziad Azar, Sheffield (GB); Reza Nilifard, Herning (DK); Petrica Taras, Brande (DK); Ziqiang Zhu, Sheffield (GB)

(21) Appl. No.: 18/530,380

(22) Filed: Dec. 6, 2023

(30) Foreign Application Priority Data
Dec. 15, 2022 (EP) 22213893.5

(51) Int. Cl. H02K 9/19; F03D 9/25; F03D 80/60; H02K 1/20; H02K 7/18

(52) U.S. Cl. CPC H02K 9/19; F03D 9/25; F03D 80/60; H02K 1/20; H02K 7/1838; F05B 2220/706; F05B 2260/232

(57) ABSTRACT

An electric generator for a wind turbine is provided, including a stator and a rotor having two axial ends opposed to each other, wherein a liquid cooling arrangement for cooling the stator by guiding a cooling liquid through the stator is provided, wherein at least two side ports which are arranged at the two opposite axial ends of the stator and at least one central port which is arranged at an axial center of the stator are provided, wherein the liquid cooling arrangement includes at least one fluid channel for leading the cooling liquid bidirectionally through the stator such that the cooling liquid either enters the stator through the side ports and leaves the stator through the central port or enters the stator through the central port and leaves the stator through the side ports.

### CROSS-REFERENCE TO RELATED APPLICATIONS

This application claims priority to EP Application No. 22213893.5, having a filing date of Dec. 15, 2022, the entire contents of which are hereby incorporated by reference.

### FIELD OF TECHNOLOGY

The following relates to an electric generator for a wind turbine, comprising a stator and a rotor having two axial ends opposed to each other, wherein a liquid cooling arrangement for cooling the stator by guiding a cooling liquid through the stator is provided.

### BACKGROUND

An electric generator comprises the stator and the rotor, wherein the rotor rotates relative to the stator about an axial direction. The electric generator can be a permanent-magnet generator with a plurality of permanent magnets and an electric circuit which is constituted by a plurality of stator windings forming coils. The rotation of the rotor causes a change of the magnetic field in the wires of the stator windings which in turn cause an electric current in the electric circuit. Assuming that the electric generator is provided in a wind turbine, the wind-driven rotation of the rotor causes the rotation of the rotor and, hence, the electric current in the electric circuit which is used for energy or power generation.

Since the size of modern wind turbines become larger and larger, higher wind turbine output powers are generated. However, higher output powers result in higher torque densities in the electric generator which in turn cause higher operating temperatures in the stator and the rotor. Hence, it is essential to sufficiently cool these components, particularly the stator, since the stator- or wire windings are strongly affected by these high temperatures. To mitigate the temperature of the wire- or stator windings and also the temperature of the permanent magnets, air- and liquid cooling systems are disclosed in the state of the conventional art, particularly in EP 2 518 868 A1, EP 2 182 619 A1 and CN 110 676 980 A. In these cooling systems, a cooling liquid is guided through the stator.

### SUMMARY

An aspect relates to an improved cooling concept for an electric generator.

To solve this problem, according to embodiments of the present invention, the electric generator as described initially is characterized in that at least two side ports which are arranged at the two opposite axial ends of the stator and at least one central port which is arranged at an axial center of the stator are provided, wherein the liquid cooling arrangement comprises at least one fluid channel for leading the cooling liquid bidirectionally through the stator such that the cooling liquid either enters the stator through the side ports and leaves the stator through the central port or enters the stator through the central port and leaves the stator through the side ports.

Embodiments of the present invention are based on the idea that not the complete amount of the cooling liquid has to be guided through the entire axial length of the stator. According to embodiments of the present invention, a cooling liquid current is split into several branches, wherein each branch is guided through a respective part of the axial length of the stator. The fluid channel can be shaped such that at all axial positions of the stator, the cooling fluid of the respective branch passes this position only once, particularly to avoid a meander-like structure of the fluid channel. In summary, all axial parts of the stator can be flown through and, hence, cooled by at least one of the branches. The flowing direction of the cooling liquid within the branches can be opposite to each other such that the bidirectional flow is created. As a consequence, for each of the branches, the time span while the respective cooling liquid flows through the stator and the respective length of the flow path through the stator is decreased such that the temperature of the cooling liquid flowing through the stator is lower compared to the case where the cooling liquid flows through the entire axial length of the stator. Thus, the temperature difference between the cooling liquid and the stator is larger at all axial positions such that the energy or heat transfer from the stator to the cooling liquid is larger. Hence, the cooling efficiency is improved.

According to a first embodiment of the present invention, the cooling liquid enters the stator through the side ports and leaves the stator through the central port. In this embodiment, the side ports constitute an entrance port each and the central port constitutes an outlet port for the cooling fluid. In this embodiment, two cooling fluid currents or flows are provided, where each current is guided into the stator through the side ports. Regarding the axial direction, these two currents can have opposite flow directions which point towards each other. After flowing through the respective axial sections of the stator, these two currents can combine or unify and leave the stator through the central port.

According to a second embodiment of the present invention, the cooling liquid enters the stator through the central port and leaves the stator through the side ports. In this embodiment, the side ports constitute an outlet port each and the central port constitutes an entrance port for the cooling fluid. Also in this embodiment, two cooling fluid currents or flows are provided, where each current is guided into the stator through the central port or ports. Regarding the axial direction, these two currents can have opposite flow directions which point away from each other. The cooling fluid can be guided within one current and be split into at least two currents before, when or after entering the stator. After flowing through the respective axial sections of the stator, these two currents can leave the stator through the side ports.

The axial direction of the stator can be defined by the axis or direction about the rotor is rotating. The stator can be cylindrical or hollow-cylindrical in shape, wherein the longitudinal direction of the respective cylinder can define the axial direction. A radial direction can be defined as the direction pointing radially outwards from the axial direction. A circumferential direction can be defined as the direction pointing tangentially away from the radial direction, i.e., into the direction in which a point which rotates about the axial direction is moving.

The axial end of the stator can consist of the outermost axial part of the stator and particularly the part of the stator which is immediately adjacent to the outermost axial part. If the stator is cylindrical or hollow-cylindrical in shape, the outermost axial part is one of the axial front faces of the stator. The axial center of the stator can consist of the middle axial section of the stator. The axial center can be defined as the part of the stator which is arranged between the axial ends.

The generator can comprise a housing, wherein the stator and the rotor are arranged within the housing. While the stator is non-rotating, the rotor can rotate about the axial direction. The stator can comprise a stator body which can be carried by a, particularly cylindrical shaped, stator support structure. The stator body can have a segmented structure comprising several, exemplarily six, segments. The stator body can comprise a stator yoke and a plurality of teeth which protrude into the radial direction and/or which can be evenly spaced along the circumferential direction. Two adjacent teeth can laterally delimit a slot each, wherein the stator windings for realizing the coils are arranged within the slots. The windings can comprise end-windings having particularly a curved shape to connect the windings arranged in two adjacent slots. The rotor can comprise a plurality of permanent magnets which arranged, particularly evenly spaced, along the circumferential direction.

The liquid cooling arrangement can constitute a closed system. In an embodiment, the cooling liquid circulates in a cooling circuit, particularly comprising a pump for circulating the cooling liquid and at least one chiller unit, e.g., a heat exchanger and/or a condenser and/or an evaporator to cool the cooling fluid before it is again guided through the stator. The cooling circuit splits up into several separate branches before or within the stator.

The at least one fluid channel or at least the part of the at least one fluid channel which is arranged in the stator can consist of at least one pipe or of at least one duct. The at least one pipe or the at least one duct is made of one single piece, which is particularly connected with further elements, e.g., at least one stub, constituting or being connected with the respective port. The pipe or duct can be made of a material with a high thermal conductivity, e.g., a metal like steel or the like.

The at least one fluid channel or at least the part of the at least one fluid channel which is arranged in the stator can be constituted by at least one hollow section of the stator. Openings of the surface of the stator leading into the hollow section can constitute the respective ports.

The fluid channel has a longitudinal direction, wherein the fluid flowing through the fluid channel flows along the longitudinal direction. Hence, the longitudinal direction can be defined by the flow path of the cooling liquid flowing through the respective fluid channel. The longitudinal direction can be linear and/or bent and/or can even comprise angles. If the longitudinal direction is linear or straight, particularly over the entire length of the fluid channel, the longitudinal direction of the fluid channel can be the axial direction of the stator.

At least one of the longitudinal ends of the at least one fluid channel or at least one stub which is connected with one of the longitudinal ends of at least one the fluid channel can constitute the respective side port. Additionally, or alternatively, a longitudinal center of the at least one fluid channel or a lateral opening arranged at the longitudinal center, respectively, can be connected with at least one stub which constitutes the respective central port. The longitudinal end and/or the stub can protrude from the surface of the stator, wherein the longitudinal end and/or the stub can be connected with a connection pipe of the liquid cooling arrangement. The connection pipe, which can also be a, particularly flexible, tube or hose, can be a part of the cooling circuit and can lead to the pump and/or the chiller unit. The connection pipe can be made of a plastic or metallic material and can be particularly constituted by a bendable metal- or PTFE-hose. The connection pipe can be connected to the fluid channel, e.g., the pipe or duct, by a connection means like a hose clamper and/or can be plugged on the longitudinal end of the pipe.

The electric generator according to embodiments of the present invention can be characterized in that the cooling liquid enters the stator through the side ports along the axial direction or the radial direction and leaves the stator through the central port along a radial direction. Alternatively, the cooling liquid can enter the stator through the central port along the radial direction and leaves the stator through the side ports along the axial direction or the radial direction. These configurations can be realized by respective shapes of the fluid channels and/or components which are connected with the fluid channels, particularly the stubs. If the cooling liquid leaves or enters the stator through the side ports along the axial direction, the side ports can be arranged on the outermost axial part of the stator. If the cooling liquid leaves or enters the stator through the side ports and/or the central port along the radial direction, the respective port can be arranged on a circumferential side of the stator.

In a possible embodiment of the electric generator according to the present invention, the fluid channel comprises two longitudinal ends which constitute or communicate with one of the side ports arranged at opposite axial ends of the stator each, wherein the fluid channel comprises a longitudinal center section which constitutes or communicates with the at least one central port. In this embodiment, at least one fluid channel which can be the or a pipe or duct extends through the entire axial length of the stator, wherein the longitudinal ends of this fluid channel constitute or communicate with the side ports. In the longitudinal center section of the fluid channel, particularly in the middle of the fluid channel, the central port can be arranged. The central port can be constituted by a lateral opening of the fluid channel or by a stub which is connected to the fluid channel. In this embodiment, both branches of the liquid cooling arrangement are guided within the same fluid channel.

The electric generator according to embodiments of the present invention can be characterized in that at least one first fluid channel and at least one second fluid channel and at least two central ports are provided. In this embodiment, the first fluid channel and the second fluid channel, which are particularly pipes or ducts, comprise two longitudinal ends each. One of the longitudinal ends of each of the fluid channels communicates with one of the side ports and the other longitudinal end constitutes or communicates with one of the central ports. Hence, in this embodiment, at least two fluid channels are provided, wherein each of the fluid channels constitute or communicate with one of the side ports and one of the central ports. In this embodiment, the branches of the liquid cooling arrangement are guided within several fluid channels. One of the longitudinal ends of the respective fluid channel can be connected with the central port by an elbow stub.

If the at least one first fluid channel and the at least one second fluid channel and the at least two central ports are provided, the longitudinal directions of the fluid channels can extend collinearly along the axial direction. In this embodiment, each fluid channel extends over a certain axial part of the stator. Particularly, the fluid channels comprise equal lengths such that the flow paths of the cooling liquid of the branches are equal in length.

Alternatively, the longitudinal directions of the fluid channels can extend offset to each other with respect to a radial direction and/or a circumferential direction. In this embodiment, the longitudinal directions of the fluid channels are shifted along the radial direction and/or the circumferential direction. Hence, the fluid channels are not collinearly with respect to each other. Particularly, the longitudinal directions of the fluid channels can extend along the axial direction. In this case, the longitudinal directions of the fluid channels are parallel to the axial direction but are shifted along the radial direction and/or the circumferential direction.

It is desired that the first fluid channel and the second fluid channel overlap each other with respect to the axial direction. In this embodiment, the axial sections of the stator in which one of fluid channels is located can intersect. Hence, the cooling effect of the respective part of the stator where the fluid channels overlap each other is enhanced.

The fluid channels can extend through the stator at least partially along an inclined direction with respect to the axial direction. In this embodiment, there is an angle between the longitudinal direction of the fluid channel and the axial direction, wherein this angle is greater than 0° and less than 90°, particularly greater than 5° and less than 20°, exactly 10°. Assuming that the stator is a hollow component, particularly with the shape of a hollow cylinder, one of the longitudinal ends can be located at one of the outermost axial parts of the stator and the other longitudinal end can be arranged at or in the hollow space of the stator.

In an embodiment of the electric generator according to the present invention, an air gap is arranged between the stator and the rotor, wherein at least one air cooling arrangement for guiding air through the air gap is provided. In this embodiment, the air cooling arrangement and the liquid cooling arrangement constitute a hybrid cooling arrangement where air as well as the cooling liquid is used as a cooling means. Hence, a system is realized where a cooling effect for the stator as well as for the rotor is realized. Cooling the rotor might be necessary, since the permanent magnets of the rotor can be heated during the energy production. The air gap can have a width in the order of millimeters.

The air cooling arrangement and the liquid cooling arrangement can work independently from each other. However, the air cooling arrangement and the liquid cooling arrangement can be linked by a heat exchanger such that heat can be transferred from the air to the cooling liquid and/or vice versa.

The air cooling arrangement can be an open system where air from an environment of the wind turbine is guided through the air gap and then emitted into the environment again by a fan. Alternatively, the air cooling arrangement can constitute a closed system, i.e., a circuit where the air is circulated. A fan for moving the air can be provided as well as a chiller unit in the air cooling arrangement.

At least two air side ports which are arranged at the opposite axial ends of the air gap can be provided, wherein the air enters the air gap through one of the air side ports and leaves the air gap through the other air side port. In this embodiment, air enters the air gap, regarding the axial direction, from the one side and leaves the air gap on the other side. Hence, a unidirectional air flow through the air gap can be realized. The stator and the rotor can be arranged within a housing of the electric generator. The area in the housing which is located at the outermost axial part of the stator and of the rotor can constitute the air side port.

In another embodiment of the present invention, at least two air side ports which are arranged at the opposite axial ends of the air gap and at least one air central port which is arranged at an axial center of the air gap are provided, wherein the air either enters the air gap through the air side ports and leaves the air gap through the air central port or enters the air gap through the air central port and leaves the air gap through the air side ports. In this embodiment, the air current is split into several branches, wherein each branch is guided through a respective part of the axial length of the air gap. The flowing direction of the air within the branches can be opposite to each other. Hence, a bidirectional air flow can be created in the air gap.

In an embodiment, the stator comprises at least one air duct which extends through the stator along the radial direction, wherein the air central port communicates with the air gap by the air duct. Particularly, the stator can comprise a plurality of axial portions which are arranged along the axial direction, wherein the portions are separated from each other by the at least one air duct. The air ducts can be distributed, particularly evenly, along a certain axial part of the stator, particularly over the complete axial length of the stator. The air can enter or leave the air gap via the air ducts. In this embodiment, the air additionally flows through the stator and causes an additional cooling effect regarding the elements of the stator, particularly the stator- or wire windings.

The electric generator according to embodiments of the present invention can comprise a distributed stator winding. In this embodiment, each coil or winding is housed or arranged in different slots which are not adjacent to each other. Having the distributed stator winding, the coil- or winding temperatures are expected to be higher on the axial ends than in axial center. Hence, in this embodiment, the cooling liquid enters the stator through the side ports and leaves the stator through the central port. The same holds true for the air of the air cooling arrangement.

Alternatively, the electric generator according to embodiments of the present invention can comprise a concentrated stator winding. In this embodiment, each coil or winding is wound around one tooth or, in other words, housed in two adjacent slots. Having the concentrated generator winding, the coil- or winding temperatures are expected to be higher in the axial center than on the axial ends. Hence, in this embodiment, the cooling liquid enters the stator through the central port and leaves the stator through the side ports. The same holds true for the air of the air-cooling arrangement.

Additionally, embodiments of the present invention relate to a wind turbine, comprising at least one electric generator according to the foregoing description. All advantages and features which have been described with respect to the electric generator according to embodiments of the present invention can be applied to the wind turbine according to embodiments of the present invention and vice versa.

The wind turbine can comprise a tower on which a nacelle is arranged and a hub with several, particularly three, blades. The hub can be rotated about the axial direction, wherein the respective rotation is driven by wind which interacts with the blades. The rotation of the hub can be transferred to the rotor of the electric generator by a main shaft which extends along the axial direction. The total height of the wind turbine can be in the order of tens or hundreds of meters. The output power of the wind turbine can be in the range of multi-Megawatts, particularly between 1 and 40 Megawatts. The wind turbine can be an onshore- or an offshore wind turbine.

### BRIEF DESCRIPTION

Some of the embodiments will be described in detail, with reference to the following figures, wherein like designations denote like members, wherein:

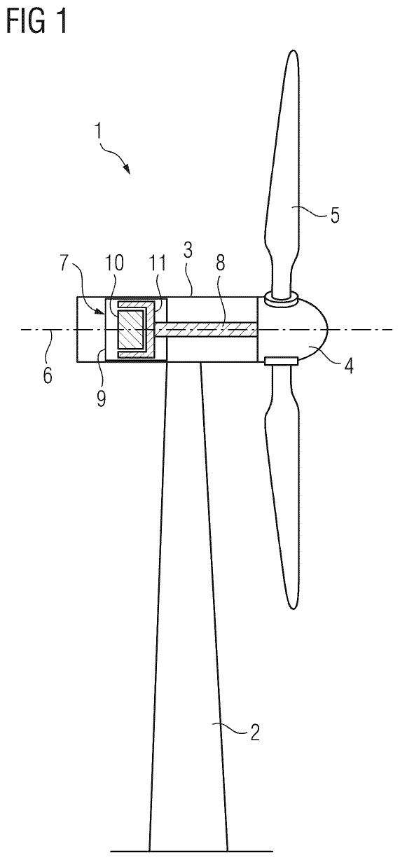

FIG. 1 a view of a wind turbine according to an embodiment of the invention comprising an electric generator according to an embodiment of the invention,

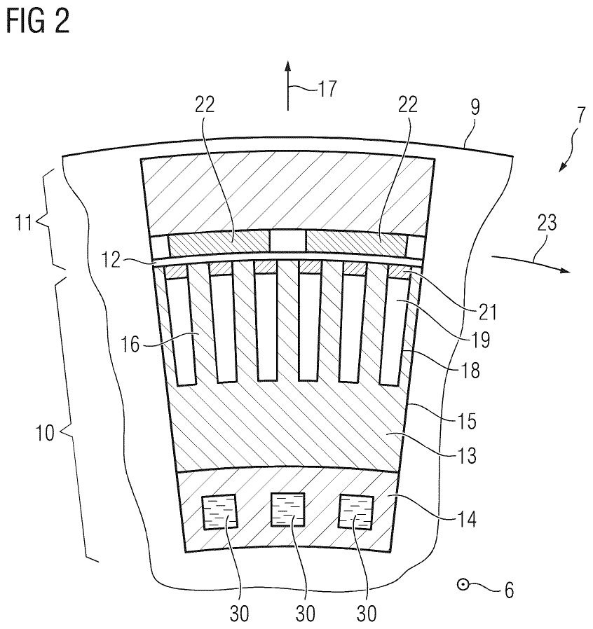

FIG. 2 a view of a radial cut through the electric generator of the wind turbine of FIG. 1,

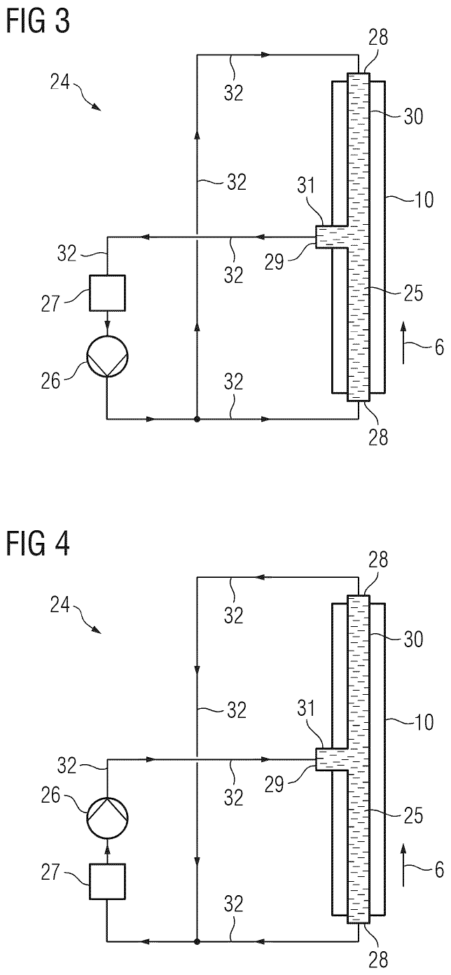

FIG. 3 a view of a liquid cooling arrangement of a first concrete embodiment of the generator of the wind turbine of FIG. 1,

FIG. 4 a view of a liquid cooling arrangement of a second concrete embodiment of the generator of the wind turbine of FIG. 1,

FIG. 5 a view of an axial cut through the stator of a third concrete embodiment of the generator of the wind turbine of FIG. 1,

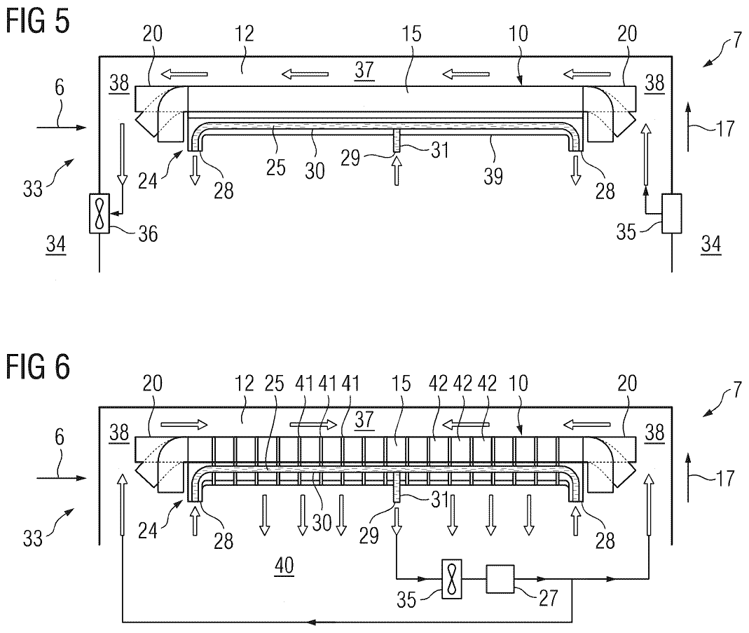

FIG. 6 a view of an axial cut through the stator of a fourth concrete embodiment of the generator of the wind turbine of FIG. 1,

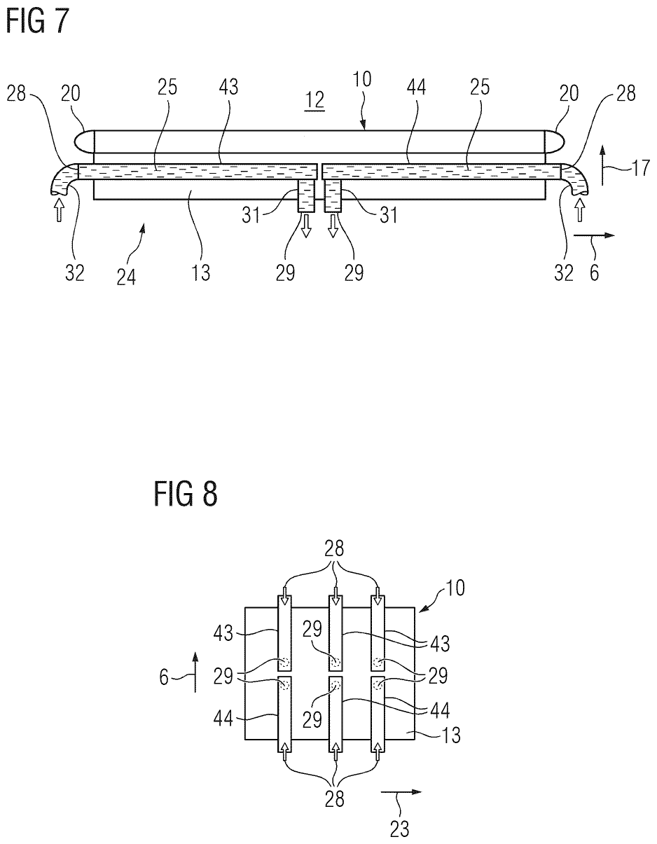

FIG. 7 a view of an axial cut through the stator of a fifth concrete embodiment of the generator of the wind turbine of FIG. 1,

FIG. 8 a top view of the stator of FIG. 7 according to a first possible configuration of the fifth concrete embodiment of the generator,

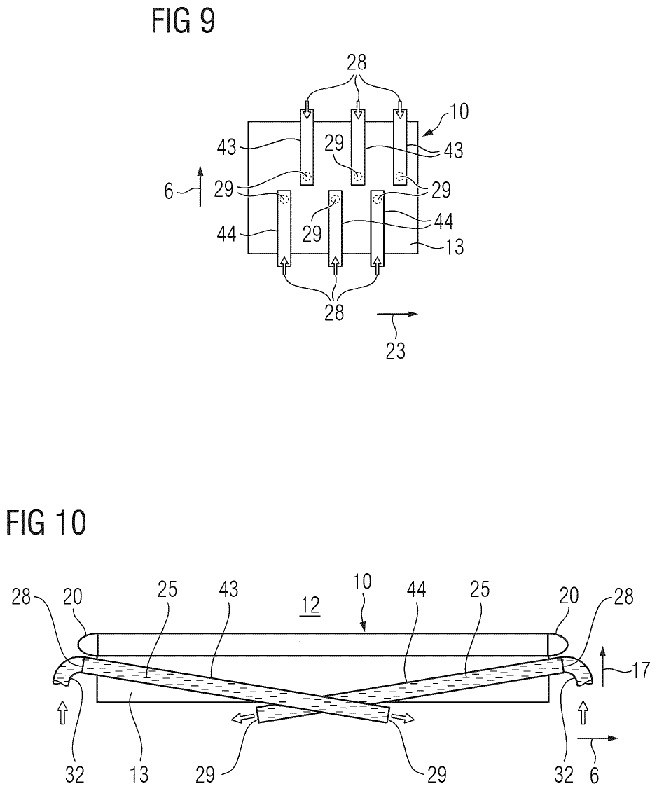

FIG. 9 a top view of the stator of FIG. 7 according to a second possible configuration of the fifth concrete embodiment of the generator,

FIG. 10 a view of an axial cut through the stator of a sixth concrete embodiment of the generator of the wind turbine of FIG. 1, and

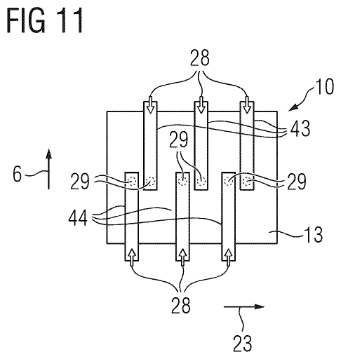

FIG. 11 a top view of the stator of FIG. 10 according to a possible configuration of the sixth concrete embodiment of the generator.

### DETAILED DESCRIPTION

FIG. 1 shows a wind turbine 1 according to an embodiment of the present invention. The wind turbine 1 comprises a tower 2 on which a nacelle 3 is arranged and a hub 4 with several, particularly three, blades 5. The hub 4 can be rotated about an axial direction 6, wherein the respective rotation is driven by wind which interacts with the blades 5. The rotation of the hub 4 is transferred to an electric generator 7 by a main shaft 8 which extends along the axial direction 6. The axial direction is arranged horizontally but can be also tilted with respect to the horizontal direction. While the total height of the wind turbine 1 is in the order of tens or hundreds of meters, the output power of the wind turbine 1 generated by the electric generator 7 is in the range of multi-Megawatts, particularly between 1 and 40 Megawatts.

The electric generator 7 comprises a housing 9, a stator 10 and a rotor 11, wherein the stator 10 and the rotor 11 are arranged within the housing 9. The stator 10 is non-rotating. The rotor 11 is connected with the main shaft 9 such that the rotation of the hub 4 is transferred to the rotor 11 which can also rotate about the axial direction 6.

FIG. 2 shows a cross section through a segment of the electric generator 7, wherein the sectional plane is perpendicular to the axial direction 6. An air gap 12 with a thickness of a few millimeters is arranged between the stator 10 and the rotor 11. The stator 10 comprises a stator body 13 which is carried by a stator support structure 14 which has a cylindrical shape. The stator body 13 and the support structure 14 have a segmented structure each which is not explicitly shown in the figures. Exemplarily, six segments form these components.

The stator body 13 comprises a stator yoke 15 and a plurality of teeth 16 which protrude into a radial direction 17. The teeth 16 are evenly spaced along a circumferential direction 23. Two adjacent teeth 16 laterally delimit a slot 18 each. Within the slots 18, stator windings 19 for realizing coils are arranged. The windings 19 comprise end-windings 20 which have a curved shape and connect the windings 19 of several, particularly adjacent, slots 18. For separating the stator windings 19 from the air gap 12, wedges 21 are arranged at the radial ends of the slots 18.

The rotor 11 comprises a plurality of permanent magnets 22 which are arranged evenly spaced along the circumferential direction 23.

The electric generator 7 furthermore comprises a liquid cooling arrangement 24 for cooling the stator 10 by guiding a cooling liquid 25 through the stator 10. Details regarding a first concrete embodiment of the liquid cooling arrangement 24 are shown in FIG. 3. In this embodiment, the liquid cooling arrangement 24 constitutes a circuit where the cooling fluid 25 circulates within a system constituted by connection pipes 32 and the stator 10. The cooling fluid 25 is driven by a pump 26 and conditioned by a chiller unit 27 which can comprise or be a heat exchanger and/or a condenser and/or an evaporator or the like. As can be seen in FIG. 3, the stator 10 comprises two side ports 28 which are arranged at axial ends of the stator. Furthermore, the stator 10 comprises a central port 29 which is arranged at an axial center of the stator 10. For leading the cooling liquid 25 through the stator 10, the stator 10 comprises a fluid channel 30 which is constituted by a pipe or a duct. The pipe is made of one single piece of metal. It is also possible that the fluid channel 30 is constituted by a hollow section of the stator 10.

As can be seen in FIG. 3, the cooling liquid 25 enters the stator 10 through the side ports 28 and leaves the stator 10 through the central port 29. Within the fluid channel 30, a bidirectional flow of the cooling liquid 25 with two flowing branches is realized, wherein the flowing directions of the cooling liquid 25 in these branches are opposed to each other and are directed along a longitudinal direction of the fluid channel 30 which is parallel to the axial direction 6. In the axial center of the stator 10, the flowing branches of the cooling liquid 25 are joined together such that the cooling liquid 25 leaves the stator 10 through the central port 29 as a single flowing branch.

In the embodiment of FIG. 3, the fluid channel 30 comprises two longitudinal ends which protrude from the stator surface and constitute the side ports 28. Hence, the side ports 28 are arranged at opposite axial end faces of the stator 10. Each of the side ports 28 is connected with one of the connection pipes 32. On an axial center of the stator 10, the fluid channel 30 comprises a longitudinal center. The longitudinal center comprises a lateral opening of the pipe or duct. At this lateral opening, the fluid channel 30 is connected with a stub 31 which constitutes the central port 29, wherein the stub 31 is connected with one of the connection pipes 32.

Regarding the embodiment of FIG. 3, the stator 10 comprises a distributed stator winding 19. This means that each coil extends over several slots 18 which are not adjacent to each other. Since for the distributed stator winding 19, the temperatures of the stator windings 19 near the axial ends are expected to be higher than in the axial center, it is advantageous that the cooling liquid enters the stator 10 at the axial ends to ensure a sufficient cooling effect of these parts of the stator 10 with higher temperatures.

FIG. 4 shows the liquid cooling arrangement 24 for the electric generator 7 according to a second embodiment of the present invention. Basically, the structure of the liquid cooling arrangement 24 of FIG. 4 is the same as the structure of the liquid cooling arrangement 24 of FIG. 3, apart from the differences which will be described next. Since the pump 26 pumps the cooling liquid 25 into the other direction than in the liquid cooling arrangement 24 of FIG. 3, the cooling liquid 25 enters the stator 10 through the central port 29 and leaves the stator 10 through the side ports 28. In the embodiment of FIG. 4, also a bidirectional flow of the cooling fluid 25 through the fluid channel 30 is realized.

Regarding the embodiment of FIG. 4, the stator 10 comprises a concentrated stator winding. This means that each coil is wound around one tooth 16 such that the respective coil is housed in two adjacent slots 18. Since for the concentrated stator winding 19, the temperatures of the stator windings 19 near the axial ends are expected to be lower than in the axial center, it is advantageous that the cooling liquid enters the stator 10 at the axial center to ensure a sufficient cooling effect of these parts of the stator 10 with higher temperatures.

Although in FIGS. 3 and 4 the liquid cooling arrangement 24 are closed systems, it is possible that the liquid cooling arrangement 24 is an open system where a cooling liquid from the outside of the wind turbine 1 can be used for cooling the electric generator 1.

With reference to FIG. 5, a third concrete embodiment of the electric generator 7 according to the present invention is described. FIG. 5 shows an axial cut through the stator 10 and the air gap 12. FIG. 5 shows a part of the liquid cooling arrangement 24 which is similar to the embodiment as shown in FIG. 4. Hence, also in the embodiment of FIG. 5, the cooling liquid 25 enters the stator 10 through the central port 29 and leaves the stator 10 through the side ports 28.

In contrast to the embodiment of FIG. 4, however, the fluid channel 30 is shaped such that the cooling liquid 25 enters the stator 10 through the central port 29 along the radial direction 17 and leaves the stator 10 through the side ports 28 also along the radial direction 17. In contrast to this, in the embodiment of FIGS. 3 and 4, the fluid channel 30 is shaped such that the cooling liquid 25 enters the stator 10 through the central port 29 along the radial direction 17 and leaves the stator 10 through the side ports 28 along the axial direction 6. The direction of the cooling liquid 25 entering or leaving the stator 10 has impact on the connections between the ports 28, 29 with the connection pipes 32, which are not explicitly shown in the figures. However, the flow direction of the cooling liquid 25 of the embodiment of FIG. 5 can also be such as it is described with respect to the embodiment of FIG. 3 and vice versa.

In the embodiment of FIG. 5, an air-cooling arrangement 33 for guiding air 37 through the air gap 12 is provided. In some embodiments, the air-cooling arrangement 33 in FIG. 5 is an open system, i.e., air 37 from the outside 34 of the generator 7 is guided through the air gap 12. For this, the generator housing 9 comprises an inlet 35 and an outlet 36, wherein air 37 is sucked through the inlet 35 into the generator 7 and expelled through the outlet 36. A fan is provided in the outlet 36 to suck air 37 from the outside 34, i.e., the interior of a canopy of the nacelle 3, into the generator 7. Alternatively, the air 37 can be ambient air of the wind turbine 1. In this embodiment, the canopy of the nacelle 3 comprises the inlet 35 and the outlet 36. The air 37 which flows through the air gap 12 provides a cooling effect for the stator 10 and the rotor 11, particularly for the permanent magnets 22.

The air-cooling arrangement 33 comprises two air side ports 38 which are arranged at the opposite axial ends of the air gap 12. The air 37 enters the air gap 12 through one of the air side ports 38 and leaves the air gap through the other air side port 38. Hence, a unidirectional air flow through the air gap 12 is realized.

With reference to FIG. 6, a fourth concrete embodiment of the electric generator 7 according to the invention is shown. The structure of the liquid cooling arrangement 24 of FIG. 6 is similar to the embodiment of FIG. 3. One difference, however, is that in FIG. 5, the fluid channel 30 is arranged in a water- or cooling jacket 39 of the stator 10, while in the stator 10 of FIG. 6, the fluid channel 30 is located within the yoke 15 or, as it is indicated in FIG. 2, in the support structure 14. Another exemplary difference is that the cooling liquid 25 enters the stator 10 via the side ports 28 and leaves the stator 10 via the central port 29.

In the embodiment of FIG. 6, an air-cooling arrangement 33 which differs from the air-cooling arrangement 33 of FIG. 5 is provided. In contrast to the air-cooling arrangement 33 of FIG. 5, the air-cooling arrangement 33 of FIG. 6 is a closed system. In other words, the air 37 circulates within an air circuit which comprises a fan and a chiller unit.

The air-cooling arrangement 33 of FIG. 6 comprises two air side ports 38 which are arranged at the opposite axial ends of the air gap 12. Furthermore, an air central port 40 which is arranged at an axial center of the air gap 12 is provided. The air 37 enters the air gap 12 through the air side ports 38 and leaves the air gap 12 through the air central port 40. Hence, in this embodiment, a bidirectional flow of the air 37 in the air gap 12 is realized. Alternatively, the air 37 can enter the air gap 12 through the air central port 40 and can leave the air gap 12 through the air side ports 38.

To realize the air flow between the air gap 12 and the air central port 40, these sections are connected via air ducts 41 which extend through the stator 10 along the radial direction 17. The stator 10 comprises a plurality of axial portions 42 which are arranged along the axial direction 6, wherein the portions 42 are separated from each other by the air ducts 41. The air ducts 41 are evenly distributed along the axial direction 6.

While this is not shown in the other figures, the air-cooling arrangement 33 which has been explained with the help of FIGS. 5 and 6 can be provided for all other explained embodiments of the electric generator 7.

FIG. 7 shows a fifth concrete embodiment of the electric generator 7 according to the present invention. In this embodiment, the liquid cooling arrangement 24 comprises a first fluid channel 43 and a second fluid channel 44. Additionally, two central ports 29 are provided. Each of the fluid channels 43, 44 comprise two axial ends, wherein one of these ends constitute one of the side ports 28 and communicates with one of the central ports 29, namely by the stub 31 or a respective elbow stub. In this embodiment, the fluid channels 43, 44 are arranged within the support structure. However, it is also possible that the fluid channels 43, 44 are arranged in the stator yoke 15 or in the water- or cooling jacket 39.

FIG. 8 shows a first possible configuration to realize the embodiment of FIG. 7. FIG. 8 shows a top view on the stator 10 or the concrete distribution of the fluid channels 43, 44, respectively. In this configuration, the longitudinal directions of the fluid channels 43, 44 extend collinearly along the axial direction 6. Concretely, several pairs of such fluid channels 43, 44 are provided, while FIG. 8 shows three of these pairs.

FIG. 9 shows the same view on the stator 10 as FIG. 8 regarding a second possible configuration to realize the embodiment of FIG. 7. In this configuration, the longitudinal directions of the fluid channels 43, 44 extend offset to each other and along the axial direction.

Concretely, these directions are offset with respect to the circumferential direction 23. Additionally, or alternatively, these directions can be offset with respect to the radial direction 17. In the configuration of FIG. 9, several pairs of such fluid channels 43, 44 are provided, while FIG. 9 shows three of these pairs. The fluid channels 43, 44 of each of these pairs have an offset into the circumferential direction 23 in FIG. 9. While this is not shown in FIG. 9, the first fluid channel 43 and the second fluid channel 44 can overlap each other with respect to the axial direction 6.

FIGS. 10 and 11 show a sixth embodiment of the electric generator 7 according to the invention. FIG. 10 shows the same view on the stator 10 as FIG. 7 and FIG. 11 shows the same view on the stator 10 as FIGS. 8 and 9. In this embodiment, a first fluid channel 43 and a second fluid channel 44 and two central ports 29 are provided. The fluid channels 43, 44 comprise two longitudinal ends each, wherein one of the longitudinal ends of each of the fluid channels 43, 44 constitute one of the side ports 28 and the other end constitutes one of the central ports 29. The longitudinal directions of the fluid channels 43, 44 extend offset to each other. In contrast to the embodiment of FIGS. 7 to 9, the fluid channels 43, 44 in FIGS. 10 and 11 extend through the stator 10 along an inclined direction with respect to the axial direction 6. In other words, the fluid channels 43, 44 extend along the axial direction 6 and along the radial direction 17. Consequently, there is an angle between the axial direction 6 and the longitudinal direction of the fluid channels 43, 44 which is exemplarily 10°. Since one of the axial ends of each of the fluid channels 43, 44 constitutes one of the central ports 29, the stub 31 is not needed in this embodiment. Hence, only one single piece is needed to constitute each of the fluid channels 43, 44. Hence, the production of the respective stator 10 is simplified.

As can be seen in FIG. 11, also in this embodiment the longitudinal direction of the fluid channels 43, 44 overlap each other with respect to the axial direction 6 such that the axial center of the stator 10 is cooled more efficiently.

Regarding the production of the electric generator 7 according to embodiments of the present invention, in the following two concrete and exemplary methods are described. According to a first possible production method, the pipes constituting the fluid channels 30, 43, 44 can be inserted into the stator 10, particularly into the support structure 14 and/or into the stator yoke 15 using a shrink-fitting technique. This technique ensures a sufficient contact between the fluid channels 30, 43, 44 with other components of the stator 10 to allow for a sufficient heat transfer from the cooling liquid 25 to these components. This technique can be used for all embodiments which have been described before. According to a second possible production method, which particularly corresponds to the embodiment of FIG. 5, the separate water- or cooling jacket 39 is built together with the fluid channels 30, 43, 44. The water- or cooling jacket 39 can then be pressed, bolted or welded to the support structure 14 and/or the stator yoke 15.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An electric generator for a wind turbine, comprising:
a stator; and a rotor having two axial ends opposed to each other;
a liquid cooling arrangement for cooling the stator by guiding a cooling liquid through the stator;
at least two side ports which are arranged at the two opposite axial ends of the stator and at least one central port which is arranged at an axial center of the stator;
wherein the liquid cooling arrangement comprises at least one fluid channel for leading the cooling liquid bidirectionally through the stator such that the cooling liquid either enters the stator through the at least two side ports and leaves the stator through the at least one central port or enters the stator through the at least one central port and leaves the stator through the at least two side ports.

2. The electric generator according to claim 1, wherein the at least one fluid channel or at least the part of the at least one fluid channel which is arranged in the stator includes at least one pipe or of at least one duct and/or is constituted by at least one hollow section of the stator.

3. The electric generator according to claim 2, wherein at least one of the longitudinal ends of the at least one fluid channel or at least one stub which is connected with one of the longitudinal ends of at least one the fluid channel constitutes a respective side port and/or that a longitudinal center of the at least one fluid channel is connected with at least one stub which constitutes a respective central port.

4. The electric generator according to claim 1, wherein the cooling liquid either enters the stator through the at least two side ports along an axial direction or a radial direction and leaves the stator through the at least one central port along the radial direction or that the cooling liquid enters the stator through the at least one central port along the radial direction and leaves the stator through the at least two side ports along the axial direction or the radial direction.

5. The electric generator according to claim 1, wherein
the fluid channel comprises two longitudinal ends which constitute or communicate with one of the at least two side ports arranged at opposite axial ends of the stator each, wherein the fluid channel comprises a longitudinal center section comprising a stub, which constitutes or communicates with the at least one central port, or
at least one first fluid channel and at least one second fluid channel and at least two central ports are provided, wherein the first fluid channel and the second fluid channel comprise two longitudinal ends each, wherein one of the longitudinal ends of each of the fluid channels constitutes or communicates with one of the at least two side ports and the other longitudinal end constitutes or communicates with one of the central ports.

6. The electric generator according to claim 5, wherein the at least one first fluid channel and the at least one second fluid channel and the at least two central ports are provided, wherein the longitudinal directions of the fluid channels extend collinearly along an axial direction.

7. The electric generator according to claim 5, wherein the at least one first fluid channel and the at least one second fluid channel and the at least two central ports are provided, wherein the longitudinal directions of the fluid channels are offset to each other with respect to a radial direction and/or a circumferential direction.

8. The electric generator according to claim 7, wherein the first fluid channel and the second fluid channel overlap each other with respect to an axial direction.

9. The electric generator according to claim 7, wherein the fluid channels extend through the stator at least partially along an inclined direction with respect to the axial direction.

10. The electric generator according to claim 1, wherein an air gap is arranged between the stator and the rotor, wherein at least one air cooling arrangement for guiding air through the air gap is provided.

11. The electric generator according to claim 10, wherein at least two air side ports which are arranged at the opposite axial ends of the air gap are provided, wherein the air enters the air gap through one of the air side ports and leaves the air gap through the other air side port.

12. The electric generator according to claim 10, wherein at least two air side ports which are arranged at the opposite axial ends of the air gap and at least one air central port which is arranged at an axial center of the air gap are provided, wherein the air either enters the air gap through the air side ports and leaves the air gap through the air central port or enters the air gap through the air central port and leaves the air gap through the air side ports.

13. The electric generator according to claim 12, wherein the stator comprises at least one air duct which extends through the stator along a radial direction, wherein the air central port communicates with the air gap by the air duct.

14. The electric generator according to claim 1, wherein the electric generator comprises a distributed stator winding or a concentrated stator winding.

15. A wind turbine, comprising at least one electric generator according to claim 1.
